(19) United States
(12) Patent Application Publication
(10) Pub. No.: US 2025/0052355 A1
(43) Pub. Date: Feb. 13, 2025

(54) INSERT TUBE FOR LINING PIPELINES OR DUCTS

(71) Applicant: IMPREG GMBH, Ammerbuch (DE)

(72) Inventor: Daniel WILL, Wildberg (DE)

(21) Appl. No.: 18/722,903

(22) PCT Filed: Nov. 17, 2022
(86) PCT No.: PCT/EP2022/082319

§ 371 Date: Jun. 21, 2024

(30) Foreign Application Priority Data
Dec. 22, 2021 (DE) 10 2021 134 231.7

(51) Int. Cl. F16L 55/165

(52) U.S. Cl. CPC F16L 55/1656

(57) ABSTRACT

A liner hose for lining pipes or ducts comprises an inner film, an outer film facing an inner wall of the pipe or duct in the installed state and at least one reinforcing layer arranged between the inner film and the outer film. The reinforcing layer contains a reinforcing material which is impregnated with a curable reaction material. The reaction material contains a solid and a solvent mixture, wherein the solid in the reaction material has a proportion which is less than 65 percent by weight. In an embodiment the solvent mixture is a mixture of styrene and/or vinyltoluene and at least one solvent which is not styrene or vinyltoluene. The styrene and/or vinyltoluene has a proportion of between 5 and 80 and preferably between 15 and 50 percent by weight in the solvent mixture.

### CROSS REFERENCE TO RELATED APPLICATIONS

This application is a national stage application under 35 U.S.C. § 371 and claims the benefit of PCT Application No. PCT/EP2022/082319 having an international filing date of 17 Nov. 2022, which designated the United States, which PCT application claimed the benefit of German Patent Application No. 102021134231.7 filed 22 Dec. 2021, the disclosures of each of which are incorporated herein by reference in their entireties, for all purposes.

### BACKGROUND OF THE INVENTION

### 1. Field of the Invention

The invention relates to a liner hose for lining pipes or ducts in need of refurbishment, and in particular to the reactive resin with which one or more reinforcing layers of the liner hose are impregnated.

### 2. Description of the Prior Art

Liner hoses, also known as “liners”, are used for the reconstruction and refurbishment of damaged pipes and ducts. The liner hoses contain at least one reinforcement layer whose reinforcement material is impregnated with a reaction material. The reinforcing material often consists of a glass fiber scrim or a combination of a glass fiber mesh and a random fiber layer (e.g. polyester needle felt), wherein the glass fiber mesh can in turn comprise several mesh layers. The reaction material hardens under the influence of UV radiation, water vapor or hot water. However, reaction materials that cure at normal temperature are also used occasionally.

To refurbish a damaged pipe, the liner hose is pulled into the damaged pipe or inverted in it (known as the inversion process) and then expanded using compressed air so that the liner hose adheres to the inner surface of the pipe. The reaction resin is then cured using UV radiation or steam so that the liner hose forms a liquid-tight and usually also gas-tight inner jacket surface of the refurbished pipe or duct section.

Unsaturated polyester resins are usually used as the reaction material, but occasionally epoxy or vinyl ester resins are also used. Both polyester resins and vinyl ester resins usually consist of 45 to 70 percent by weight of unsaturated polyester or vinyl ester (solid) and the remaining percent by weight of styrene as a solvent. The styrene dissolves the unsaturated polyester or vinyl ester, which is semi-solid to solid at room temperature, and forms a liquid resin with the ester, the viscosity of which can be adjusted over a wide range. A viscosity of around 600 to 1000 mPa*s is usually set to impregnate the reinforcing material.

On the other hand, the styrene acts as a reaction partner for the reactive double bonds in the unsaturated polyester or vinyl ester during crosslinking. Without styrene, these esters cannot be cured efficiently.

The high market share of polyester resins is mainly due to the fact that they have a good price-performance ratio. In addition, the unreinforced material already provides useful mechanical properties after curing; these are further improved by the embedded reinforcing material. Cross-linking by radical polymerization leads to very rapid curing.

However, styrene may not be harmless to health during processing. Styrene leads to lung cancer in animal experiments with mice—but not with rats and other laboratory animals. In addition, the mutagenic potential of styrene has been the subject of controversial debate for many years. Styrene evaporates in large quantities both during the impregnation of the reinforcing material, which is usually carried out in the factory, and during curing under heat and/or UV light, which is noticeable in the form of an odor that is not unpleasant but is clearly perceptible.

The same applies to vinyl toluene, which is a methyl styrene that has similar properties to styrene and is also considered a health problem. As far as styrene is mentioned in the following, this also applies analogously to vinyl toluene.

Due to health concerns, a replacement for styrene has therefore been sought for some time in connection with liner hoses. However, the high demands placed on the resin system for liner hoses make the search for alternatives to styrene difficult. The resins must cure without splitting products (e.g. water or methanol), and preferably at a high curing speed. After curing, a minimum level of toughness and pronounced chemical resistance is required to ensure at least 50 years of resistance to municipal wastewater.

A methacrylate is sometimes used as an alternative to styrene; the corresponding resin systems are then referred to as styrene-free. However, methacrylates are considerably more expensive than styrene, which, in view of the considerable quantities required for liner hoses, can make refurbishment with a liner hose uneconomical. In addition, methacrylate-based resins have the disadvantage of lower reactivity. As less and less heat or UV light reaches the outer reinforcement layers, especially with thicker hoses, curing can sometimes take a very long time.

Epoxy resins, on the other hand, are basically styrene-free. However, some of their ingredients are allergenic and not completely odorless. In addition, due to their short pot life, epoxy resins can only be applied shortly before the liner hose is drawn in, which is not desirable in terms of either work hygiene or production technology.

In order to compensate for the disadvantageous properties of the methacrylate used as a styrene substitute, peroxides are occasionally added to the resin, as is known from DD 133 953. Due to the decomposition of the peroxide and the resulting release of radicals, polymerization is also triggered in those areas of the liner hose that are not or not sufficiently reached by UV light. This is a self-reinforcing effect, as polymerization is an exothermic reaction that generates the heat for further decomposition of the peroxide.

However, peroxides are unstable compounds and can exhibit explosive and oxidizing behavior, especially in higher concentrations and at elevated temperatures.

EP 2 525 130 A1 solves the problem of insufficient through-curing by applying a special coating (i.e. a type of bonding agent) to the glass fibers of the reinforcing layers, which reduces the absorption coefficient of the liner hose for the UV light in such a way that a peroxide-free reaction mass can be cured with UV light even with tube thicknesses of more than 10 mm. In practice, however, this approach has not become established for various reasons. These include, above all, the costs incurred for applying the special coating, which add to the already high costs for the methacrylates.

The problems explained above mean that most liner hoses are still impregnated with a reaction material that consists of 30 to 55 percent styrene by weight.

### SUMMARY OF THE INVENTION

The object of the invention is to provide a liner hose that at least partially solves the problems associated with the use of styrene.

This object is achieved by a liner hose for lining pipes or ducts, comprising an inner film, an outer film facing an inner wall of the pipe or duct in the installed state, and at least one reinforcing layer arranged between the inner film and the outer film and comprising a reinforcing material impregnated with a curable reaction material. The reaction material contains a solid and a solvent mixture, wherein the solid in the reaction material has a solids proportion of between 45 and 65 percent by weight. The solvent mixture is a mixture of styrene and/or vinyltoluene and at least one solvent which is not styrene or vinyltoluene, wherein the styrene and/or vinyltoluene in the solvent mixture has a proportion of between 5 and 80 percent by weight, preferably between 15 and 50 percent by weight.

The inventor has recognized that styrene or vinyl toluene on the one hand and styrene-free solvents such as methacrylate (in particular butanediol dimethacrylate) on the other hand are chemically well compatible and can be processed very well as a mixture. With such a mixture, the total proportion of styrene and/or vinyl toluene in the reaction material can be reduced from the previous 30 to 55 percent by weight to, for example, 5 to 20 percent by weight. However, the low proportion of styrene and/or vinyl toluene ensures that the reaction material cures quickly and completely after the liner hose is drawn in under the influence of heat and/or UV radiation. This is due to the fact that vinyltoluene and even more so styrene increase the reactivity (exothermicity) of the reaction material. If, for example, only 15% by weight of the methacrylate is replaced by styrene, an increase in reactivity of around 25% is observed.

At the same time, the low proportion of styrene and/or vinyl toluene results in increased permeability to UV radiation due to the better interaction with the coating surrounding the glass fibers compared to methacrylate, which also has a positive effect on UV-induced curing.

The result is a liner hose that cures excellently even with greater hose thicknesses, but only pollutes the environment and people in the vicinity with a very small amount of styrene or vinyl toluene.

Low-styrene resins are known in the state of the art. However, the low styrene content is only achieved by reducing the solvent content to around 30%. This is too low for use as a reaction material in liner hoses. Preferred there—and also for some embodiments of the present invention—is a proportion of the solid in the reaction material of between 52 and 58 percent by weight.

The solid contained in the reaction material may in particular be unsaturated polyester resin or vinyl ester resin. The polyester resin may contain a combination of isophthalic acid and neopentyl glycol or a combination of orthophthalic acid and neopentyl glycol.

Another object of the invention is a lining tube obtained from a liner hose according to the invention by expanding the initially collapsed liner hose and curing the reaction material.

It is also an object of the invention to provide a method of manufacturing a liner hose for lining pipes or ducts comprising the following steps:
a) feeding a tubular inner film;
b) feeding at least one reinforcing layer, which has a reinforcing material,
c) enclosing the at least one reinforcement layer with an outer film;
d) impregnating the at least one reinforcing layer with a curable reaction material, wherein the reaction material contains a solid and a solvent mixture, and wherein the solid in the reaction material has a proportion which is between 45 and 65 percent by weight,
   wherein the solvent mixture is a mixture of styrene and/or vinyltoluene and at least one solvent which is not styrene or vinyltoluene, wherein the styrene and/or vinyltoluene in the solvent mixture has a proportion of between 5 and 80 percent by weight.

The advantages and preferred embodiments described above for the liner hose apply accordingly to the method.

### BRIEF DESCRIPTION OF THE DRAWINGS

In the following, embodiments of the invention are explained in more detail with reference to the drawings, in which:

FIG. 1 is a cross-section through a liner hose according to an embodiment after it has been installed in a damaged pipe;

FIG. 2 shows the liner hose of FIG. 1 before installation, but without the outer film.

### DESCRIPTION OF PREFERRED EMBODIMENTS

### 1. Liner Hose

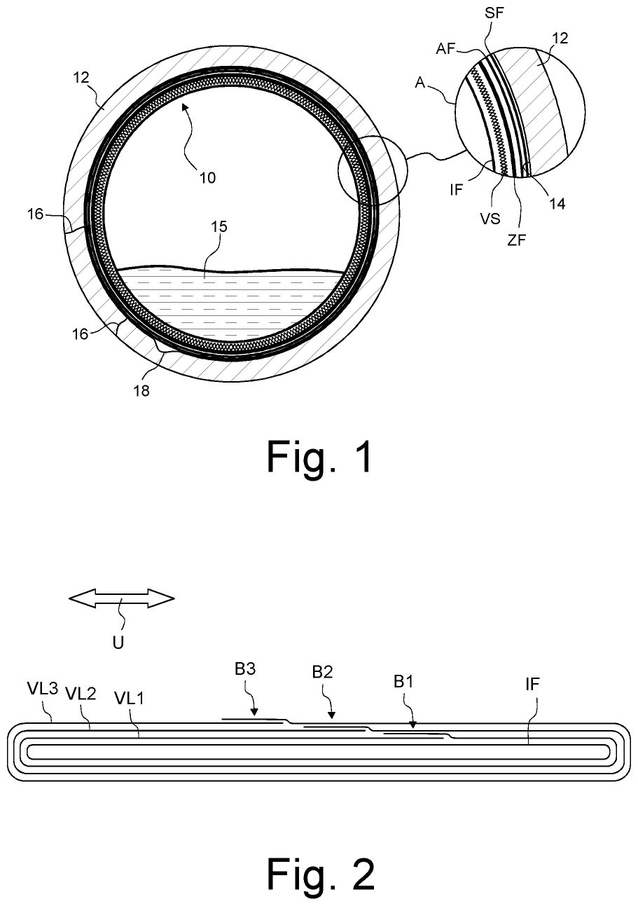

FIG. 1 shows exemplarily a liner hose 10 after it has been installed in a pipe 12. The liner hose 10 has a multi-layer structure, which can be seen more clearly in the enlarged cutout A. The liner hose 10 comprises a styrene-tight inner film IF and an outer film AF which, when installed, faces an inner wall 14 of the pipe 12. Between the outer film AF and the inner wall 14, there is also a protective film SF in the illustrated embodiment, which protects the liner hose 10 from damage when it is pulled into the pipe 12.

A reinforcing layer VS comprising several reinforcing layers is arranged between the inner film IF and the outer film AF. Each reinforcing layer contains a reinforcing material which is impregnated with a reaction material that can be cured under UV radiation. The composition of the reaction material is explained in section 2.

Furthermore, in the illustrated embodiment, the liner hose 10 comprises an intermediate film ZF, which is arranged between the outer film AF and the reinforcing layer VS.

The liner hose 10, and in particular its hardened reinforcement layer VS, forms a new liquid- and gas-tight inner jacket surface of the pipe 12, so that liquid 15 carried in it cannot escape from cracks 16, breakouts 18 or other damage to the pipe 12.

FIG. 2 shows the liner hose 10 before installation in the pipe and without the intermediate film ZF and the outer film AF. Three reinforcing layers VL1, VL2, VL3 are wrapped around the tubular and flat inner film IF, which together form the reinforcing layer VS shown in FIG. 1 and each have a glass fiber fabric as reinforcing material, which is impregnated with the reaction material that can be cured under UV light. Each reinforcing layer VL1, VL2, VL3 has an overlap area B1, B2 or B3, at which longitudinal sides of the reinforcing layers VL1, VL2, VL3 lying opposite each other in a circumferential direction U overlap loosely (i.e. without being joined).

### 2. Reaction Material

In the embodiment shown, the reaction material is a polyester resin that consists of 52% by weight of an unsaturated polyester resin as a solid and 48% by weight of a solvent mixture. The solvent mixture is a mixture of a bit more than 31 percent by weight of styrene and just under 69 percent by weight of butanediol dimethacrylate (BDDMA). This corresponds to a total proportion of styrene in the reaction material of 15 percent by weight and a total proportion of butanediol dimethacrylate in the reaction material of 33 percent by weight.

The following table contains the results of comparative tests. These tests were also based on a solvent mixture content of 48% by weight; the styrene content in the reaction material was varied.

| Proportion of styrene | Proportion of BDDMA | |
|---|---|---|
| [percent by weight] | [percent by weight] | Reactivity [kJ/kg] |
| 0 | 48 | 200 |
| 15 | 33 | 250 |
| 48 | 0 | 320 |

The first and last lines correspond to the state of the art, i.e. a styrene-free reaction material or a reaction material that contains only styrene as a solvent. It can be seen that the reactivity can be increased to 250 KJ/kg with a comparatively small styrene content of 15%, which is sufficient for curing insert hoses with greater hose thicknesses.

If the 15 percent by weight of styrene is replaced by 15 percent by weight of vinyl toluene, the reactivity is reduced slightly to 240 KJ/kg.

1. A liner hose for lining pipes or ducts, wherein the liner hose comprises:
an inner film,
an outer film facing an inner wall of the pipe or the duct in the installed state, and
at least one reinforcing layer arranged between the inner film and the outer film and comprising a reinforcing material impregnated with a curable reaction material, wherein
the reaction material contains a solid and a solvent mixture, and wherein
the solid in the reaction material has a proportion of less than 65 percent by weight,
wherein
the solvent mixture is a mixture of at least one of styrene or vinyltoluene and at least one solvent which is not styrene or vinyltoluene, wherein at least one of the styrene or vinyltoluene in the solvent mixture has a proportion of between 5 and 80 percent by weight.

2. The liner hose of claim 1, wherein the at least one of styrene or vinyltoluene in the solvent mixture has a proportion of between 15 and 50 percent by weight.

3. The liner hose according to claim 10, wherein the proportion of solid material in the reaction material is between 52 and 58 percent by weight.

4. The liner hose of claim 1, wherein the reaction material has a total content of the at least one of styrene or vinyltoluene of between 5 and 20 percent by weight.

5. The liner hose of claim 1, wherein the at least one solvent which is not styrene or vinyltoluene is a methacrylate.

6. The liner hose of claim 1, wherein the solid contains unsaturated polyester resin or vinyl ester resin.

7. The liner hose of claim 6, wherein the polyester resin contains a combination of isophthalic acid and neopentyl glycol or a combination of orthophthalic acid and neopentyl glycol.

8. A lining tube obtained from a liner hose of claim 1 by expanding the initially collapsed liner hose and curing the reaction material.

9. A method of manufacturing a liner hose for lining pipes or ducts, comprising:
a) feeding a tubular inner film;
b) feeding at least one reinforcing layer, which has a reinforcing material,
c) enclosing the at least one reinforcement layer with an outer film;
d) impregnating the at least one reinforcing layer with a curable reaction material, wherein the reaction material contains a solid and a solvent mixture, and wherein the solid in the reaction material has a proportion which is less than 65 percent by weight,
wherein
the solvent mixture is a mixture of at least one of styrene or vinyltoluene and at least one solvent which is not styrene or vinyltoluene, wherein the at least one of styrene or vinyltoluene in the solvent mixture has a proportion of between 5 and 80 percent by weight.

10. The liner hose of claim 1, wherein the proportion of solid material in the reaction material is more than 45 percent by weight.

11. The liner hose of claim 5, wherein the methacrylate is butanediol dimethacrylate.

12. A liner hose for lining pipes or ducts, wherein the liner hose comprises
an inner film,
an outer film facing an inner wall of the pipe or the duct in the installed state, and
at least one reinforcing layer arranged between the inner film and the outer film and comprising a reinforcing material impregnated with a curable reaction material, wherein the reaction material contains a solid and a solvent mixture,
wherein the solvent mixture is a mixture of at least one of styrene and vinyltoluene and methacrylate, wherein the at least one of styrene and vinyltoluene in the solvent mixture has a proportion of between 15 and 50 percent by weight.

13. A lining tube obtained from a liner hose of claim 12 by expanding the initially collapsed liner hose and curing the reaction material.
